(19) United States
(12) Patent Application Publication
(10) Pub. No.: US 2010/0076804 A1
(43) Pub. Date: Mar. 25, 2010

(54) PREVENTING SCHEDULING CONFLICTS WHEN PROPOSING NEW TIMES FOR CALENDAR EVENTS

(75) Inventor: ANGELA RICHARDS JONES, DURHAM, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/236,253

(22) Filed: Sep. 23, 2008

(51) Int. Cl. G06Q 10/00

(52) U.S. Cl. 705/8

(57) ABSTRACT

Calendar entries can be added indicating a proposed change to a calendar event to electronic calendars of all event attendees when the proposed change is pending approval. This puts the attendees on notice of a possible change in a time or place of the calendar event so that these attendees can choose not to schedule conflicting calendar events while the proposed change is pending.

### BACKGROUND

The present invention relates to the field of calendaring applications and, more particularly, to preventing scheduling conflicts when proposing new times for calendar events.

Many electronic calendar applications have the ability for invitees (e.g., users receiving a meeting/event invitation from another user) to propose a new time for a meeting upon receiving a calendar invitation. The person (termed a rescheduler) who is proposing a new time can also be granted an ability to check the calendars of the meeting chair and all other meeting participants (e.g., all users receiving invitations for the meeting) to ensure that the proposed time is conflict free at the time of the proposal. When the rescheduler sends the proposal, the meeting chair can accept the proposal, which causes meeting updates to be sent to all potential meeting participants.

Between the period that the rescheduler sends out the proposal and the time the meeting chair accepts the proposal, calendar entries of other ones of the meeting attendees may have changed. That is, one or more of the meeting attendees can schedule a calendar entry in a time slot causing a conflict with the rescheduler's proposed new meeting time.

### BRIEF DESCRIPTION OF THE SEVERAL VIEWS OF THE DRAWINGS

FIG. 1 is a flow diagram for avoiding conflicts in a calendaring system when proposing new meeting times in accordance with an embodiment of the inventive arrangements disclosed herein.

FIG. 2 is a schematic diagram of a system for avoiding conflicts in a calendaring system when proposing new meeting times in accordance with an embodiment of the inventive arrangements disclosed herein.

### DETAILED DESCRIPTION

An embodiment of the invention discloses conveying proposed new meeting times from reschedulers to all potential meeting participants. These proposed meeting times can be indicated within calendars of each of the potential meeting participants so that each potential meeting participant is placed on notice of the proposed new meeting time, which helps to avoid inadvertent scheduling conflicts. This notice can be added to calendars when a rescheduler proposes a new time before a meeting chair has elected accept the new time, which finalizes the change. In one embodiment, an indication that the proposed new time is tentative (has not been accepted by the meeting chair) can be placed proximate to the proposed meeting time. When the chair either accepts or rejects the proposed new time, calendar entries of all potential meeting participants can be automatically updated. For example, should a meeting chair reject the proposed new time, calendar entries indicating the proposed new time can be deleted. When the meeting chair accepts a new proposed time, calendar entries of meeting participants can be changed from a tentative event (proposed new meeting time) to a standard event (scheduled meeting time) and entries for the original meeting time can be removed from the calendars.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

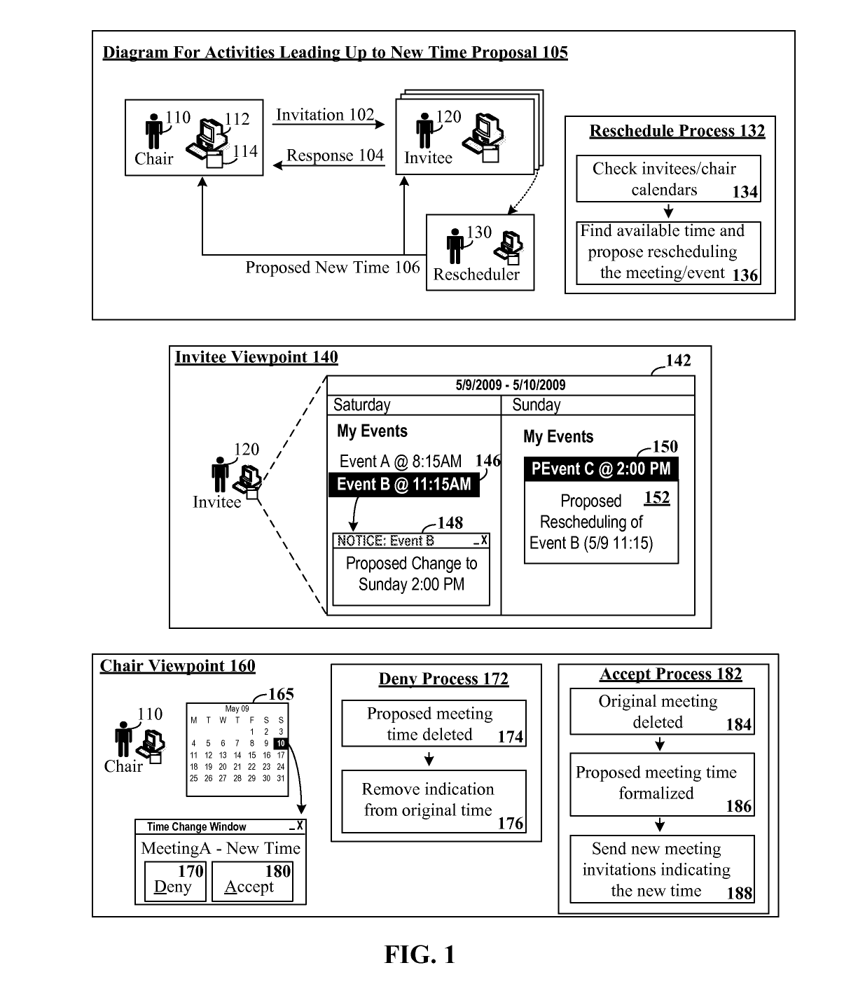

FIG. 1 is a flow diagram for avoiding conflicts in a calendaring system when proposing new meeting times in accordance with an embodiment of the inventive arrangements disclosed herein. In FIG. 1, a set of activities leading up to a new proposal for a meeting time is diagrammed 105. Once a new time 106 for a meeting is proposed, this proposed time can be reflected in calendars of other meeting invitees 120, as shown by invitee viewpoint 140. Calendars can again be changed in response to a meeting chair's 110 decision regarding the proposed time, as expressed by chair viewpoint 160.

Diagram 105 shows a chair 110 who utilizes a calendaring interface 114 presented on a computing device 112 to convey an invitation 102 to a set of invitees 120. Each of the invitees 120 convey a response 104 to the invitation 102 back to the chair 110. The response 104 can indicate acceptance of the invitation 102, an inability to attend the meeting, or can propose a different time for the meeting.

An invitee 120 who proposes a new time 106 for a meeting can be referred to as a rescheduler 130. The rescheduler 130 can use a calendaring interface to perform rescheduling process 132. In process 132, calendars of a chair 110 and the invitees 120 can be checked, as shown by step 134. An available time can be found that is compatible with the schedules of the potential meeting attendees which can be established as a proposed new time 106 for the meeting, as shown by step 136. The proposed new time 106 can be conveyed to the chair 110 and to each invitee 120.

When invitees 120 receive the proposed new time 106 this time can be reflected within an electronic calendar, as shown by viewpoint 140. That is, the conveyance of the proposed new time 106 by the rescheduler 130 automatically places the proposal on the calendars of all meeting attendees along with an indication that the proposed change is tentative and has yet to be accepted by the meeting chair 110. Interface 142 shows that an original meeting 146 can be associated with a notification 148 that proposed changes exist that may affect the meeting 146. Additionally, a calendar entry 150 can be shown for the proposed new meeting time 152. Showing the proposed meeting time 152 within invitee 120 calendars permits invitees 120 to avoid scheduling other activities in the proposed time slot, while a decision regarding the new proposed time 152 is pending.

When the chair 110 receives the proposed new time 106 an indication can be shown within his/her calendaring interface 165 along with options to accept 180 or deny 170 the change, as shown by chair viewpoint 160. If a proposed time 106 is denied, deny process 172 can be performed, where a proposed meeting time can be deleted 174 from all calendars. Any indication of a proposed change associated with the original meeting can be removed, as shown by step 176.

When the chair 110 selects an option to accept 180 the change to the meeting, acceptance process 182 can be performed. During the acceptance process 182, an original meeting entry can be deleted 184 from all meeting attendee calendars, as shown by step 184. In step 186, a proposed meeting time can be formalized, which means the proposal or tentative indication can be removed, which converts a tentative entry (e.g., entry 150) into a standard meeting entry. In step 188, new meeting invitations can be sent to all potential meeting attendees, which include invitees 120 who rejected the original meeting invitation.

As used herein, a meeting can refer to any event able to be managed by a calendaring system. The chair 110 can be a person who is an owner of a meeting event as determined by a calendaring system. An invitee 120 can be a user of the calendaring system who has been asked to participate in a meeting. The rescheduler 130 can be an invitee 120 who proposes a change 106 to a meeting to which he/she was invited.

Although the proposed change 106 has previously been focused upon changing a time of a meeting, other meeting attributes can be affected. For example, a rescheduler 130 can request a change in location of a meeting, which can affect whether other potential invitees will be able to attend (i.e., moving a meeting from one city to another can have a substantial effect on attendance).

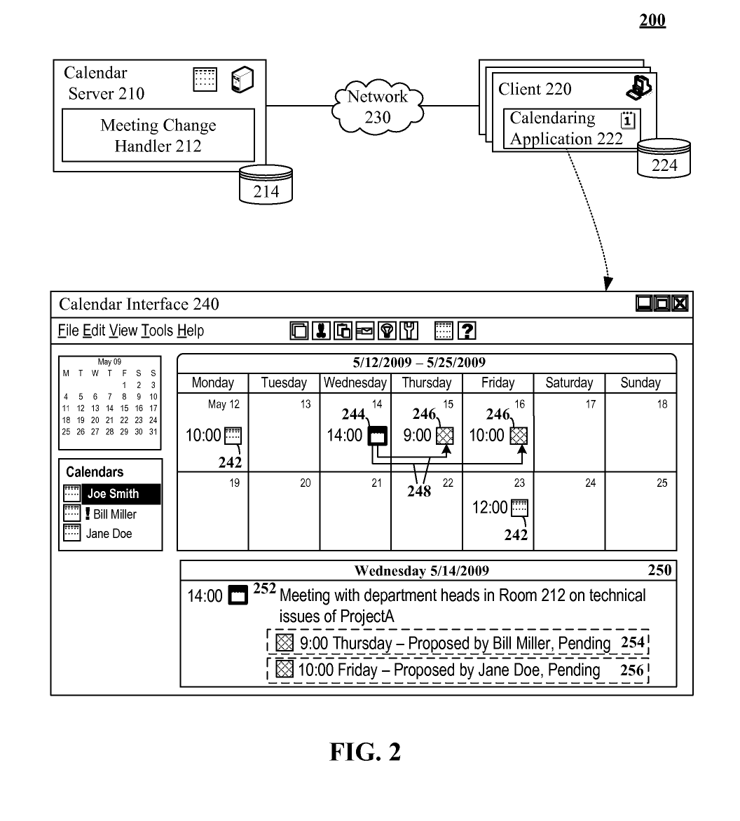

FIG. 2 is a schematic diagram of a system 200 for avoiding conflicts in a calendaring system when proposing new meeting times in accordance with an embodiment of the inventive arrangements disclosed herein. System 200 can be one contemplated implementation for carrying out the activities described in FIG. 1.

In system 200, a calendaring server 210 can be connected via a network 230 to a set of clients 220. Meeting participants (e.g., a meeting chair, an invitee, a rescheduler, etc.) can access user specific calendars via the clients 220. A calendaring application 222 can execute on each client 220. Each calendaring application 222 can include a user interface, such as interface 240. A meeting change handler 212 can perform programmatic functions related to a proposed meeting change. For example, the handler 212 can place proposed meeting times within calendars of attendees, can perform actions that indicate one or more proposed changes exist for a scheduled meeting, and the like. Calendaring event data can be stored in data stores 214 and 224.

Interface 240 can utilize a number of different visual indicators 242-246 to denote meetings (e.g., calendaring events). One indicator 242 can be associated with “standard” meetings that do not have any proposed time/location changes pending. Another indicator 244 can denote a current meeting time, which does have one or more proposed time/location changes pending. Still another indicator 246 can denote a proposed meeting change, which is currently pending action (either acceptance or denial of the change) by a meeting chair. A visual indicator 248 can appear on interface 240 that visually shows a relationship between a currently scheduled meeting time and a proposed changed time.

No inherent limitation exists regarding a number of proposed and pending changes able to be tracked per event. The disclosure contemplates N proposals per event, where N is a can include zero or more proposals. As shown, two different proposed changes exist for the meeting currently scheduled for Wednesday, September 14. Meeting detail view 250 shows details of the originally scheduled meeting 252. Each pending change 254, 256 is shown under the originally scheduled meeting 252.

Any type of indicator can be utilized to indicate which calendar entries have pending proposed time changes and which calendar entries represent a pending proposed time change. Text annotations, graphics, highlighting, color coding, font adjustments, fly-over windows, unique audio tones, and the like are a few possible indicators able to be utilized to alert users of calendar events associated with a pending time change proposal.

Client 220 can be any computing device able to present a user interface through which a user can interact with their electronic calendar. For example, client 220 can include a personal computer, a smart phone, a personal data assistant, a Web tablet, and the like.

Calendar server 210 can be implemented as a set of one or more physical computing devices able to facilitate calendar management. The calendar server 210 can be a real or virtual device. Server 210 can be implemented as a stand-alone device, or as a set of distributed devices.

The network 230 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network can include local components and data pathways necessary for communications to be exchanged among computing device components and between integrated device components and peripheral devices. The network can also include network equipment, such as routers, data lines, hubs, and intermediary servers which together form a packet-based network, such as the Internet or an intranet. The network can further include circuit-based communication components and mobile communication components, such as telephony switches, modems, cellular communication towers, and the like. The network can include line based and/or wireless communication pathways.

The various data stores of system 200, which include data stores 214 and 224 can be physically implemented within any type of hardware including, but not limited to, a magnetic disk, an optical disk, a semiconductor memory, a digitally encoded plastic memory, a holographic memory, or any other recording medium. The data stores can be a stand-alone storage unit as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

Although system 200 shows a client-server embodiment, other configurations are contemplated. For example, in one embodiment, clients 220 can directly exchange meeting related data with each other without requiring server 210 interactions. In such an example, functionality ascribed to handler 212 can be implemented within calendaring application 222.

Interfaces shown in FIGS. 1-2, such as interface 240, are for illustrative purposes only and should not be construed to limit the invention in any regard. Arrangements, elements, and options present in the interfaces can vary from implementation to implementation. Each of the interfaces can be implemented as a graphical user interface (GUI), a voice user interface (VUI), a text user interface (TUI), a multi-modal interface, and the like.

The diagrams in the FIGS. 1-2 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for preventing scheduling conflicts comprising:
adding calendar entries indicating a proposed change to a calendar event to electronic calendars of all event attendees when the proposed change is pending approval.

2. The method of claim 1, further comprising:
adding an annotation indicating a pending proposed change to entries for an original calendar event to the electronic calendars of all event attendees when the proposed change is pending approval, wherein the original calendar event is the event to which the proposed change applies.

3. The method of claim 1, wherein the proposed change indicates a new time for the calendar event, and wherein the added calendar entries are associated with the new time.

4. The method of claim 3, further comprising:
checking the calendars of all event attendees for conflicts with the new time when establishing the new time.

5. The method of claim 2, further comprising:
detecting an decision from a user in charge of the calendar event regarding the proposed change; and
updating the added calendar entries of the electronic calendars of all event attendees in accordance with the detected decision.

6. The method of claim 5, wherein the decision is one to deny the proposed change, said updating of the added calendar entries comprising:
deleting the added calendar entries from the electronic calendars of all event attendees responsive to the decision being detected.

7. The method of claim 2, wherein the decision is one to deny the proposed change, said updating of the added calendar entries comprising:
deleting the added calendar entries from the electronic calendars of all event attendees responsive to the decision being detected; and
deleting the added annotation indicating the pending proposed change from all of the calendars.

8. The method of claim 5, wherein the decision is one to accept the proposed change, said updating of the added calendar entries comprising:
deleting from the electronic calendars of event attendees entries associated with an original calendar event to which the proposed change applies;
changing the added calendar entries in all the electronic calendars of event attendees to a standard calendar entry as opposed to a proposed, yet unconfirmed, one.

9. The method of claim 8, further comprising
sending new meeting invitations to all event attendees for the changed calendar entries, wherein responses to the meeting invitations indicate to a user in charge of the calendar event whether a responding invitee intends to attend the changed calendar event.

10. The method of claim 9, further comprising:
sending meeting invitations to all invitees of an original calendar event that refused an initial invitation for the original calendar event.

11. The method of claim 1, further comprising:
presenting indicators of the added calendar entries indicating the proposed change within user interfaces in which the calendars are presented, wherein the presented indicators distinguish the added calendar entries associated with the proposed change from other types of calendar entries.

12. The method of claim 2, further comprising:
presenting proposal indicators indicating an existence of a proposed change within user interface in which the calendars are presented, wherein the presented proposal indicators distinguish the original calendar events from other events that have no proposed changes associated with them.

13. A user interface for a calendaring application comprising:
at least one proposal interface element indicating a pending proposed change to an original calendar entry, wherein the pending proposed change indicates an desired change to the original calendar event that has yet to be decided upon by a user in charge of the original calendar event, wherein the desired change is one submitted by a user other than a user of the user interface and other than the user in charge of the original calendar event.

14. The user interface of claim 13, further comprising:
at least calendar interface element associated with the original calendar event that indicates at least one pending proposed change is associated with the original calendar event.

15. The user interface of claim 14, wherein said user interface is a graphical user interface and wherein the proposed interface element and the calendar interface element are presented in calendar controls associated with times of the pending proposed change and the related calendar event, respectively.

16. A computer program product for preventing scheduling conflicts comprising a computer usable medium having computer usable program code embodied therewith, the computer usable program code comprising:
computer usable program code configured to add calendar entries indicating a proposed change to a calendar event to electronic calendars of all event attendees when the proposed change is pending approval.

17. The computer program product of claim 16, further comprising:
computer usable program code configured to add an annotation indicating a pending proposed change to entries for an original calendar event to the electronic calendars of all event attendees when the proposed change is pending approval, wherein the original calendar event is the event to which the proposed change applies.

18. The computer program product of claim 16, wherein the proposed change indicates a new time for the calendar event, and wherein the added calendar entries are associated with the new time.

19. The computer program product of claim 16, further comprising:
computer usable program code configured to present indicators of the added calendar entries indicating the proposed change within user interfaces in which the calendars are presented, wherein the presented indicators distinguish the added calendar entries associated with the proposed change from other types of calendar entries.

20. The computer program product of claim 17, further comprising:
computer usable program code configured to present proposal indicators indicating an existence of a proposed change within user interface in which the calendars are presented, wherein the presented proposal indicators distinguish the original calendar events from other events that have no proposed changes associated with them.
